(19) United States
(12) Patent Application Publication
(10) Pub. No.: US 2011/0231317 A1
(43) Pub. Date: Sep. 22, 2011

(54) SECURITY SENSITIVE DATA FLOW ANALYSIS

(76) Inventor: WIHEM ARSAC, Biot (FR)

(21) Appl. No.: 12/727,270

(22) Filed: Mar. 19, 2010

(51) Int. Cl. G06Q 10/00; G06F 21/24; G06F 17/30

(52) U.S. Cl. 705/50; 726/21; 707/783; 726/28; 707/E17.001; 705/7.13

(57) ABSTRACT

A system and method for security-aware data flow analysis are described. In various embodiments, a system analyses relationships between users, roles, tasks, and data objects, and permissions set thereon and grants access to users to specific data objects or data fields. In various embodiments, a method for creating an authorization matrix for data used in business processes is described. The method includes analyzing organizational policies associated with functional requirements and granting access to data to users if organizational policies are complied with.

### TECHNICAL FIELD

The invention relates generally to business process modeling, and more specifically, to security sensitive data flow analysis for business processes.

### BACKGROUND

Organizations conduct business activities in compliance with various accepted standards, functional, and non-functional requirements. Business activities are modeled in business processes. Data related to the execution of business processes may contain sensitive information that may need to be handled carefully. Business processes within organizations may be designed to comply with functional requirements such as legal constraints and security properties to prevent fraudulent activities.

Business processes may be packaged as services in a Service-Oriented Architecture (SOA) implemented on computer systems of various platform types. SOA facilitates the integration and interaction of applications on various platforms via communication protocols using messages. Messages may flow between various systems, thus exposing the communication between applications and the data contained therein to different vulnerabilities and security threats.

Business processes are modeled according to various accepted standards, for example, the Business Process Modeling Notation (BPMN). A BPMN diagram uses four categories of elements to describe a business process. These are flow objects, swim lanes, connecting objects, and artifacts. Flow objects describe the behavior of a business process. Flow objects may be events and activities and may be connected to each other via sequence flows, message flows, and associations. For example, a business process can be described as a sequence of activities followed by users to achieve a business goal. An activity can be decomposed into several sub-processes, which may contribute to achieving the goal of the super-process or to achieving atomic tasks.

In today's connected communication-intensive business activities, there may be a need to ensure that data used in a business process is adequately protected in compliance with security requirements and that users performing activities within a business process may dynamically obtain the necessary security clearance to manipulate data within the business process.

### SUMMARY

These and other benefits and features of embodiments of the invention will be apparent upon consideration of the following detailed description of preferred embodiments thereof, presented in connection with the following drawings.

In various embodiments, a system is presented. In various embodiments, the system may be implemented to analyze organizational polices and grant access to data to users within a business process based on organizational policies.

In various embodiments, a system of the embodiments may create authorization matrixes specifying permissions and associations between resources, tasks, roles, data objects, and data fields.

In various embodiments, a method is presented. The method may analyze authorization information to grant permission to users to perform tasks and access data or data fields.

In various embodiments, another method is presented. The method may analyze authorization information to create an authorization matrix for data objects (and data fields thereof) according to functional requirements imposed on users, roles, tasks, and data.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system according to an embodiment.

FIG. 2 is a flow diagram of a process according to various embodiments.

FIG. 3 is a block diagram of exemplary stakeholders in a business process and relationships between the stakeholders according to various embodiments.

FIG. 4 is a flow diagram of an embodiment for creating an authorization matrix for data objects based on dynamic delegation of permissions.

FIG. 5 is a block diagram of an exemplary loan origination business process according to various embodiments.

FIG. 6 is a block diagram of a system according to another embodiment.

### DETAILED DESCRIPTION

Embodiments of techniques for security sensitive data flow analysis are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. For example, reference to vertical or horizontal direction herein can be seen as a convention and changed when practicing the invention. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

In various embodiments, a business process may describe an execution of a business goal as receiving a set of inputs, manipulating the received inputs, and producing a set of outputs. Business processes may form complex interaction patterns with other processes. A business process represents a set of activities describing a fulfillment of a business task or a collection of business tasks in a specific order. The set of activities in the specific order are also referred to as business process steps. The business process steps describe the flow of data within the business process. According to various embodiments, the order, in which the business process steps are executed in, may also be referred to as “control flow” or “business process control flow”. According to various embodiments, the manner, in which data may be manipulated in a business process, may also be referred to as “data flow” or “business process data flow”.

According to various embodiments, the business process may include, but is not limited to, activity elements, event elements, sub-process elements, tasks, data objects, and other elements.

Event elements describe “something that happens.” A “start event” acts as a trigger for a business process. An “end event” represents the result of a business process. An “intermediate event” represents something that happens between the start and end events. An intermediate event may synchronize the business process with external stimuli.

An activity describes the kind of work which is to be performed, and, generally, an atomic unit of work.

A task represents a single unit of work. Tasks may also represent human interactions (e.g., as opposed to other activities which may represent automated interactions with other business systems or business processes).

In various embodiments, performing a task within a business process may require accessing data involved in the business process. Users may be members of roles and permissions to perform tasks may be associated with such roles.

A role may be a function assigned to a user or a group of users. Within an organizational structure, users may be assigned roles according to their job function. For example, within an Information Technology (IT) landscape, a role may define security permissions applicable to a user or a group of users.

A role may be created for each function within a business entity. A role can require resources with a specific set of attributes, qualifications or skills to complete the function the role is created for. In various embodiments, resources are human or software agents that perform work within the business process. The assignment of a role to a resource provides the resource with the authorization needed to accomplish tasks and to access data. Performing a task is related to accessing data. Business objects are data objects involved in the business process. According to various embodiments, data objects provide data to execute activities within a business process. Data objects may also hold data which is a result of a completed activity. Data objects have data fields representing information that is stored and used within the business entity.

In various embodiments, functional and non-functional requirements may be imposed on a business process. Non-functional requirements can be viewed as quality attributes. They can be seen as global qualities of a software system, such as flexibility, maintainability, usability, etc.

Functional requirements are derived from statutory regulations or organizational policies that impose a certain care in handling sensitive data. For instance, there may be functional requirements specifying desired compliance of financial data and financial tools in a system with the requirements set forth in the Sarbanes-Oxley Act of 2002 (Pub. L. 107-204, 116 Stat. 745, enacted Jul. 30, 2002).

In another example of functional requirements, the Directive 95/46/EC of the Official Journal of the European Communities of 23 Nov. 1995 (L.281) is related to the protection of individuals with regard to the processing of personal data and the free movement of such data. Such regulations may specify how sensitive data should be handled.

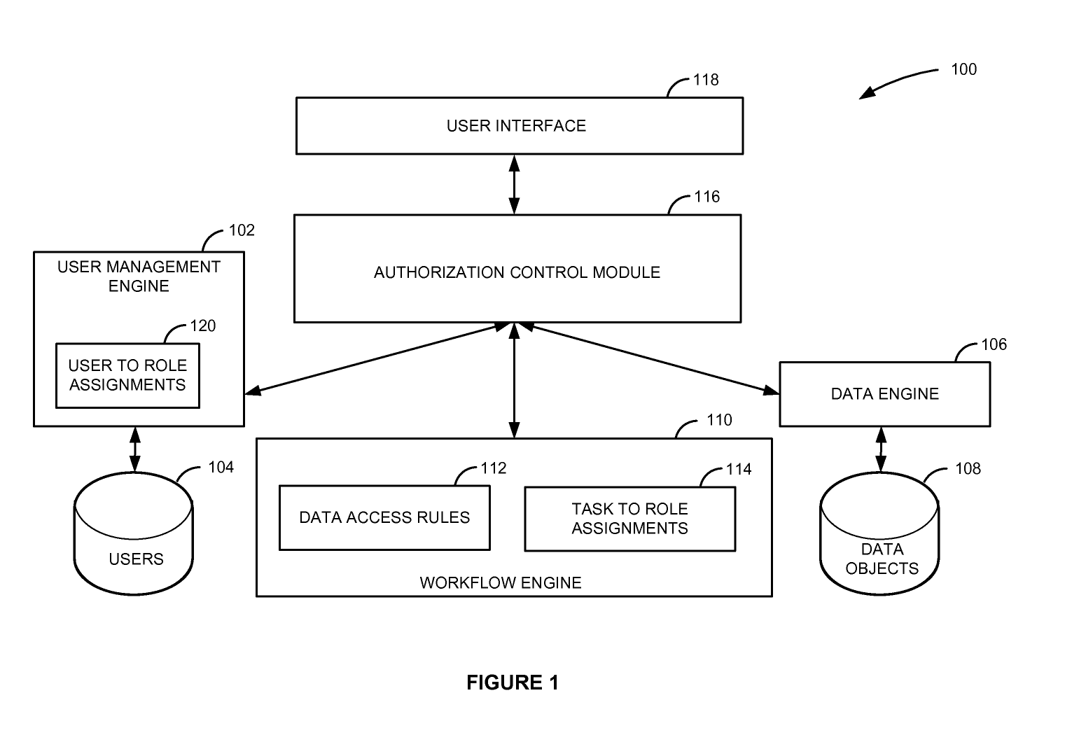

FIG. 1 is a block diagram of a system according to an embodiment. Referring to FIG. 1, the system 100 includes a user management engine 102 manages users 104 performing activities and tasks in a business process and maintains user to role assignments 120. A data engine 106 manages data objects 108 used in the business process. A workflow engine 110 maintains various policies relevant for the execution of the business process, for example, data access rules 112 and task to role assignments 114. The authorization control module 116 communicates with the user management engine 102, the data engine 106, and the workflow engine 110 to determine authorizations (e.g., security permissions) for users 104 on data objects 108 reflecting organizational policies maintained in the workflow engine 110. The user interface 118 displays business process models and business process execution details. In various embodiments, users 104 and data objects 108 may be maintained in one or more databases stored on one or more memory devices.

The authorization control module 116 ensures that organizational policies are complied with and are applied correctly. In various embodiments, the authorizations created by the authorization control module 116 may be applied to the business process and execution of the business process may be simulated on a validation platform. Thus, the business process may be validated for compliance to functional and non-functional requirements of the organization at design time.

In various embodiments, a variety of policies on data may need to be followed in an organization. For example, data confidentiality may be applied differently for different data fields of data objects. Some data fields may require extra security permissions, for example, data fields with sensitive personal data, such as gender, ethnic group, religious beliefs, political affiliation, and others. For example, in a banking business process, clerks in the bank are the users of the business process. Clerks may be granted access to certain data fields as necessary to perform activities within the business process but sensitive personal data may be kept restricted to ensure data confidentiality and austerity and prevent favoritism and discrimination. Following the banking example, a bank clerk assigned to a role “loan approval” may need to review data related to credit ratings and loan history to perform the activity “approve loan.” However, statutory and organizational requirements may be implemented in organizational policies to prevent the clerk to obtain further personal sensitive information, such as gender, race, and others. Following this approach, activities within a business process can be compliant with functional requirements of the organization.

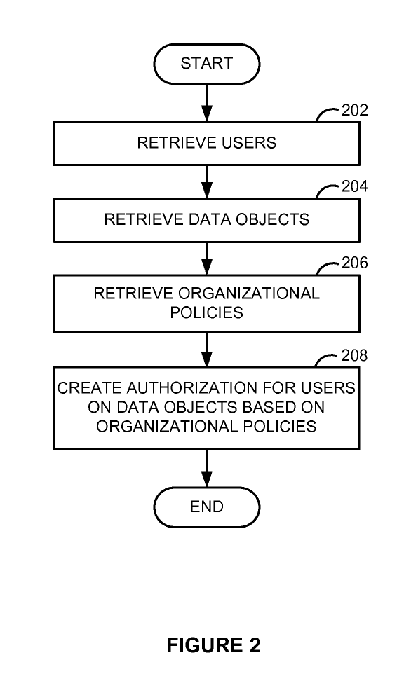

FIG. 2 is a flow diagram of a process according to various embodiments. Referring to FIG. 2, at process block 202, users in a business process are retrieved. In various embodiments, users may be stored in one or more databases on one or more memory devices. At process block 204, data objects are retrieved. Data objects represent data required for activities and tasks in the business process, or data produced as a result of activities and tasks in the business process. At process block 206, organizational policies are retrieved. The organizational policies may be relevant for one or more functional requirements, such as security requirements for data confidentiality and data austerity based on legislation or service level agreements between business partners (SLAs). At process block 208, authorization is created for users on data objects based on the retrieved organizational policies.

In various embodiments, the process as described in FIG. 2 may be performed by components as described in FIG. 1.

In various embodiments, security permissions may need to be granted to users on demand dynamically. In such cases, fine-grained data access policies may be implemented reflecting complicated relationships between users, roles, tasks, permissions, and data fields of data objects. For example, a user may need to perform a task on demand. In such cases, the user may need to have permission to perform the task delegated to them, and permission to access data relevant for the task delegated to them. Such permissions can be delegated if delegating the permissions does not violate organizational policies. Such fine-grained authorization information may be created to form access control lists (ACLs) for data objects or data fields, and several ACLs may be combined to form an authorization matrix. An authorization matrix may reflect the relationships and authorizations between all stakeholders, such as resources (e.g., users), tasks, roles, data objects, and data fields. Thus, a model of the dependencies between the stakeholders is implemented according to various embodiments.

In various embodiments, a set of permissions P defines the right to execute an operation on an object O. A permission p is a pair (f; o) where f is a function and o an object such that p⊂f×o.

In various embodiments, a pair (U, R) is a set of users, U and a set of roles R, with the following relation assignments: a user role assignment (URA), such that URA⊂U×R (mapping users to roles they are members of); and a permission role association (PRA), such that PRA⊂P×R (defining the set of permissions associated with a role).

Further, a task role assignment (TRA) may be defined where TRA⊂T×R (mapping roles to tasks they are assigned to accomplish). A permission task association (PTA), where PTA⊂P×T defines the set of permissions required to execute a task.

When users are assigned to roles (URA, PRA) authorizations needed to fulfill specific tasks are provided via the PTA.

If a task T should be delegated, a first user (U_{dr}) can delegate the permission to execute a task to a second user (U_{de}) in a role R. The delegation of permission means that the second user (U_{de}) has the permission to fulfill the task.

Further, a task delegation association (TDA) may be defined as a tuple where TDA=(T; R; U_{dr}; U_{de}; DC). In the TDA tuple, T is the delegated Task, R the delegated role, U_{dr} the first user, U_{de} the second user and DC the delegation conditions (e.g., according to organizational policies).

To provide security permissions to users of tasks for specific data fields of data objects, each data object has a list of its fields and their related access rights. The tuple (U, R, T, D) maintains access rights where U is a set of users, U, R is a set of roles, T is a set of tasks, and D is a set of data objects.

A data role assignment (DRA) maps roles to data they request access to such as DRA⊂D×R. A data permission association (DPA) defines the permission required to access a field of a data object, such that DPA⊂D×P. Access may be, for example, read-only, full-control, no-access, and others.

Thus, a model of a permission association may be created for data and role with the tuple (PDR), also specifying the DRA, DPA and PRA relationships. Following the definitions above, it can be determined that access to a data object D may be granted to a role if the following condition is met: (d; r)εDRA [symbol] {pεP|(d, p)εDPA)}⊂{p|(p, r)εPRA)}.

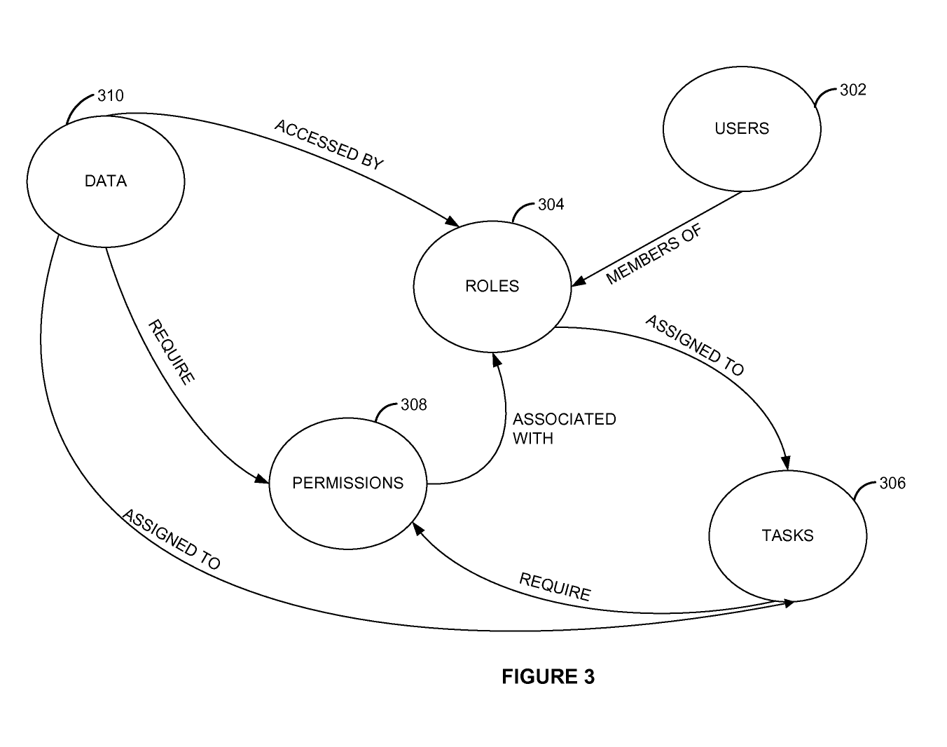

For example, referring to FIG. 3, users 302 are members of roles 304. The roles 304 are assigned to tasks 306 to accomplish them. Tasks 306 require permissions 308 to be accomplished. Further, data 310 require permissions 308 and accessed by roles 304. Permissions 308 are further associated with roles 304. Data 310 is also assigned to tasks 306 because tasks 306 may require data to be accomplished. Following the arrow from users 302 to roles 304, a set including users mapped to roles is retrieved (e.g., URA). Similarly, following the arrow from roles 304 to tasks 306, a set of roles mapped to tasks is retrieved (e.g., TRA). Following the manner above, TPA is derived following the arrow from tasks 306 to permissions 308; PRA is derived following the arrow from permissions 308 to roles 304; DRA is derived following the arrow from data 310 to roles 304; and DPA is derived following the arrow from data 310 to permissions 308.

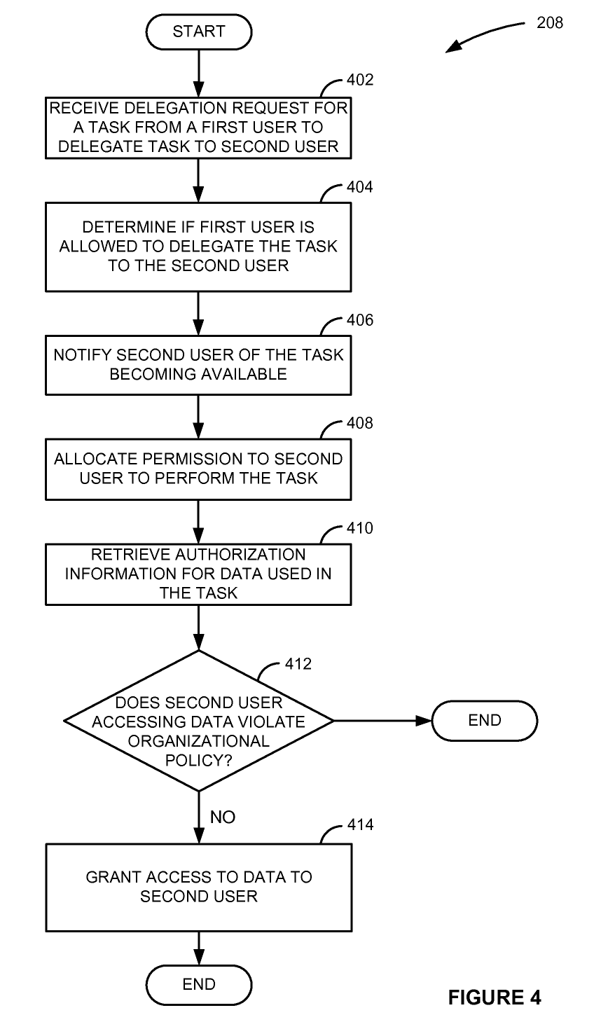

FIG. 4 is a flow diagram of an embodiment for creating an authorization matrix for data objects based on delegation of permissions as outlined in the model above. Referring to FIG. 4, at process block 402, a delegation request is received. The delegation request is from a first user wishing to delegate permission to perform a task to a second user. At process block 404, it is determined if the first user may delegate the task to the second user. This determination is performed by analyzing URA and TRA assignments under PRA and PTA permissions (e.g., may be performed by an authorization control module such as 116 in FIG. 1). If the first user has sufficient permissions under PRA and PTA, the first user can delegate the task to the second user, at process block 406, the second user is notified that the task is available. At process block 408, permission to execute the task is allocated to the second user. At this stage, the second user has permission to perform the task but may not have access to the data needed for the task. At process block 410, authorization information for the data used in the task is retrieved. To determine if the second user has permission to obtain the data, the DRA under DPA is analyzed to determine if granting access to the second user to the data (and data fields thereof depending on the task) will violate any organizational policies, at process block 412. If no organizational policies are violated, at process block 414 access to data fields of data needed for the task is granted to the second user. Consequently, an authorization matrix is created reflecting specific permissions on each data field granted to the second user under the role required to perform the delegated task. Each data field may be allocated specific permissions such as read-only, read-write, full-access, no-access and others. Thus, the second user will have permission to perform the task as delegated to them by the first user, but will only have access to data fields as permitted in organizational policies specified in DRA under DPA to ensure data is distributed on a need-to-know basis and data confidentiality and data austerity is preserved.

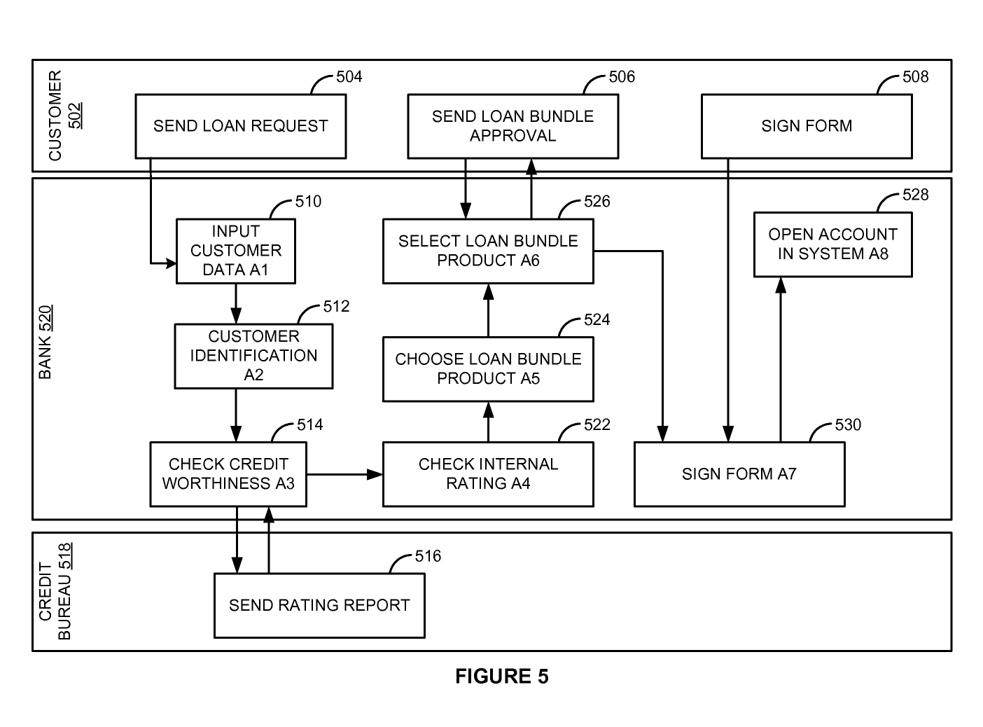

In various embodiments, a Loan Origination Business Process (LOBP) scenario may be implemented as described in FIG. 5. The LOBP is a business process that evaluates and possibly accepts a Customer (C) 502 request for a Loan Amount (LA). Referring FIG. 5, A Bank 520 (B) carries out an evaluation of the customer's credit worthiness internally and receives credit worthiness reports from Credit Bureaus (CB) 518 (e.g., as part of a send rating report 516 task).

The business entities involved in the business process are a customer C 502 requesting a loan, a bank B 520 carrying out an evaluation of the customer's credit worthiness, and a credit bureau CB 518 requested as a third-party business partner to check the credit worthiness of a customer.

The LOBP may also include the following users:
A bank customer 502 to acquire a loan (e.g., by sending a loan request 504, sending loan bundle approval 506, and signing form for loan 508).
A first clerk performing pre-processing (hereinafter B.PRC) in the bank, receiving data about customer C 502 and identifying customer C 502. Receiving data about customer C is hereinafter referred to as A1 (e.g., activity 1 at block 510) and identifying customer C is hereinafter referred to as A2 (e.g., activity A2 at block 512).
A second clerk performing post-processing (hereinafter B.POC) in the bank, responsible for checking credit worthiness (hereinafter Activity A3 and A4 at blocks 514 and 522) and selecting the most appropriate loan bundle product (hereinafter Activity A5 and A6 at blocks 524 and 526).
A manager of the bank B (hereinafter B.M), performing loan approval (e.g., as part of activity A7 at block 530).
A credit bureau supervisor (hereinafter CB.S) performing checks on credit worthiness of a customer and sending a rating report to B.POC (e.g., as part of activity A3 at block 514).

Within the LOBP scenario, Customer Data (CD) profiles may be created and stored in the bank information system (e.g., as part of Activity 8 at block 528). The fields of CD and access permissions on roles are listed in Table 1 below.

TABLE 1

| Data field | Permission | Forbidden Roles |
|---|---|---|
| ID | Full | |
| name | Read | B.POC |
| address | Read | B.POC, CB.S |
| birthDate | Read | B.POC, B.M, CB.S |
| salary | Read | B.POC, CB.S |
| gender | Read | B.POC, B.M, CB.S |
| ethnic group | No | B.PRC, B.POC, B.M, |
| | | CB.S |
| job | Read | CB.S, B.POC, B.M |
| bank account history | Full | B.POC, CB.S |
| payment behavior | Full | CB.S |
| credential feedback | Full | CB.S |

Within B 520, several roles, all with different levels of responsibility, are defined. For instance, a B.PRC (e.g., pre-processing clerk in bank) role is responsible for receiving and identifying C's request. The B.PRC role may launch and update CD. The B.POC (e.g., post-processing clerk in bank) is responsible for analyzing internal and external rating to check C's credit worthiness. The B.POC identifies the most appropriate bundle product (for example, in choose loan bundle product 524). B.POC calculates the price of the loan and submits a loan proposal and loan conditions to C (e.g., as part of A6, select loan bundle product 526). The manager (B.M, e.g. manager of the bank) is responsible for approval of the loan. As manager, the role B.M may have permission to perform all activities within the bank 520, while the role B.PRC may only have permission to perform activities 1, 2, 5, 6, and 8 at blocks 510, 512, 524, 526, and 528, respectively; and the role B.POC may have permission to perform activities 3 and 4 at blocks 514 and 522, respectively.

As seen in Table 1, each field in CD is assigned a type of permission and roles. To ensure data austerity, some roles may be prevented from accessing certain fields, for example, B.POC role is forbidden access to data fields such as name, gender, and ethnic group of CD. To enable specific access rights on specific CD fields, TRA and URA and the associated permissions PTA, PRA are combined with the DRA and the associated permission DPA, to create an authorization matrix taking into account permissions set on roles, tasks, and data (e.g., following the model described in FIG. 3). The bank system provides a list of users, roles and tasks entitled to accomplish the LOBP. During the instantiation phase of the business process workflow, the URA, TRA assignments are instantiated according to their respective permission associations.

In various embodiments, there may be a need to delegate roles from one employee (e.g., user) to another employee (e.g., user). For instance, a bank employee, acting as a PRC role, is entitled to execute the A1 activity at block 510 of the LOBP. If no other B.PRC role member is available, the employee has to delegate his current task to another bank employee, acting as a B.POC role, who is usually entitled to execute the A5 activity. The delegation may be allowed.

However, in everyday activities, the employee with the B.POC role may encounter the customer ID again and remember personal data that they acquired while executing a delegated task. Thus, principles of data austerity might be violated. Evidently, there is a need to be able to determine the possible outcomes of the business process at design time to enable business process designers to design business processes compliant with data confidentiality and data austerity principles. Using the authorization matrix based on all of URA, TRA, DRA, and their respective permission associations (e.g., PRA, PTA, and DPA), a validation tool can simulate the execution of the business process and possible pitfalls in the security properties assigned to data objects and fields thereof. Thus, compliance to security standards may be ensured at design time.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

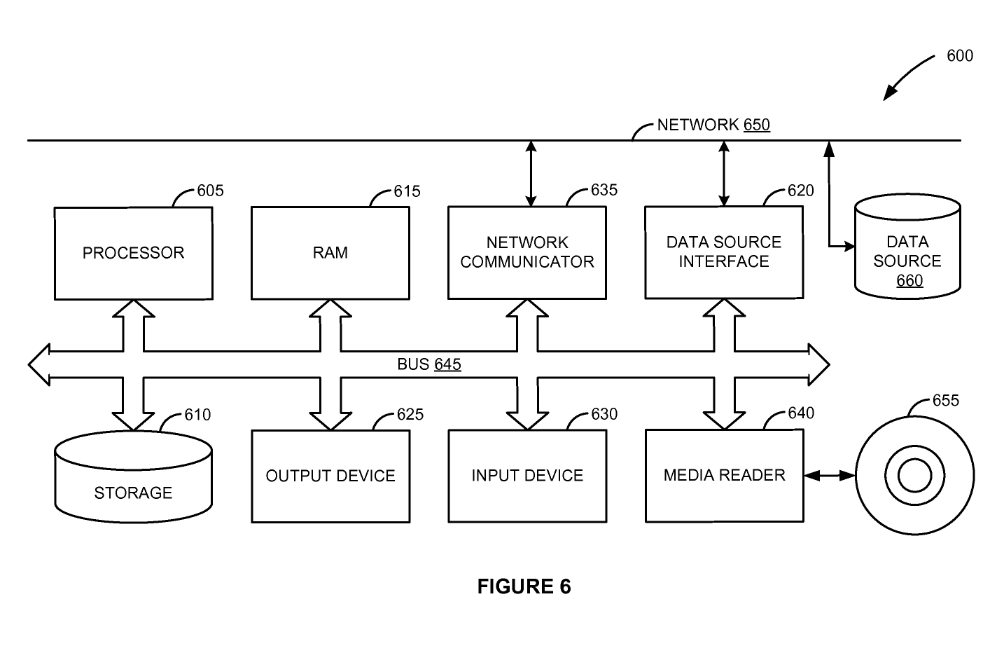

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer readable storage medium having computer readable instructions tangibly stored thereon which when executed by the computer, cause the computer to perform a method for security-aware data flow analysis, the method comprising:
receiving a delegation request from a first user to delegate a task to a second user;
allocating permission to the second user to perform the task if no organizational policies are violated;
retrieving data used in the task via a data to task association;
retrieving one or more data to role mappings of the data used in the task and one or more permissions associated with the one or more data to role mappings of the data used in the task; and
determining if access to the data used in the task can be granted to the second user based on the one or more data to role mappings of the data used in the task and the one or more permissions associated with the one or more data role to mappings of the data used in the task; and
granting access to the data used in the task to the second user.

2. The computer readable storage medium of claim 1, wherein allocating permission to the second user to perform the task comprises:
retrieving one or more user to role mappings and one or more task to role assignments for the task;
determining if the first user has permission to delegate the task to the second user; and
determining if the delegation request can be granted based on permissions associated with the one or more user to role mappings and the task to role assignments.

3. The computer readable storage medium of claim 2, wherein the method further comprises notifying the second user that the task is available.

4. The computer readable storage medium of claim 1, wherein determining if access to the data used in the task can be granted to the second user comprises:
determining a role the second user is a member of via one or more user to role mappings; and
determining if the role the second used is a member of is in the one or more data to role mappings of the data used in the task.

5. The computer readable storage medium of claim 1, wherein granting access to the data used in the task to the second user comprises determining access rights for the second user for one or more data fields of the data used in the task.

6. The computer readable storage medium of claim 5, wherein determining access rights for the second user for the one or more data fields of the data used in the task comprises:
determining one or more permissions associated with the one or more data fields of the data used in the task;
determining one or more roles associated with the one or more permissions associated with the one or more data fields of the data used in the task; and
granting access to the one or more data fields of the data used in the task to the second user if a role the second user is a member of is in the one or more roles associated with the one or more permissions associated with the one or more data fields.

7. A computerized system including a processor, the processor communicating with one or more memory devices storing instructions, the instructions comprising:
an authorization control module operable to create an authorization matrix for one or more data fields of one or more data objects;
a user engine operable to send user data to the authorization control module;
a data engine operable to send the one or more data objects to the authorization control module; and
a workflow engine operable to send authorization information to the authorization control module.

8. The computerized system of claim 7, wherein the data engine is further operable to retrieve the one or more data objects from one or more databases.

9. The computerized system of claim 7, wherein the user engine is further operable to retrieve user data from one or more databases.

10. The computerized system of claim 7, wherein the user engine is further operable to maintain one or more user to role assignments.

11. The computerized system of claim 7, wherein the workflow engine is further operable to maintain one or more data access rules and one or more task to role assignments.

12. The computerized system of claim 7, wherein the authorization control module is further operable to grant access to the one or more data objects to one or more users based on one or more organizational policies received from the workflow engine.

13. The computerized system of claim 7, further comprising a user interface operable to render graphical representations of the user data, the one or more data objects, and one or more business process elements the user data and the one or more data objects are associated with.

14. A computerized method, comprising:
retrieving one or more user data of a business process;
retrieving one or more roles mapped to the one or more user data;
retrieving one or more data objects mapped to the one or more roles; and
analyzing one or more mappings between the one or more user data, the one or more roles, and the one or more data objects to determine if a first user can be granted access to the one or more data objects.

15. The computerized method of claim 14, further comprising determining if the first user can delegate one or more tasks to a second user.

16. The computerized method of claim 14, wherein retrieving the one or more user data comprises:
retrieving one or more user to role mappings associated with the business process; and
retrieving one or more task to role mappings associated with the business process;
retrieving one or more permissions associated with the one or more user to role mappings and the one or more task to role mappings; and
determining one or more users to be able to perform one or more tasks based on the one or more permissions associated with the one or more user to role mappings and the one or more task to role mappings.

17. The computerized method of claim 14, wherein retrieving the one or more data objects comprises:
receiving one or more tasks mapped to the one or more roles;
receiving a mapping of the one or more tasks to the one or more data objects; and
identifying the one or more data objects via the mapping of the one or more tasks to the one or more data objects.

18. The computerized method of claim 14, further comprising:
receiving a mapping of the first user to the one or more roles;
determining if the first user is a member of a role mapped to one or more tasks associated with the one or more data objects.

19. The computerized method of claim 14, wherein analyzing the one or more mappings between the one or more user data, the one or more roles, and the one or more data objects to determine if the first user can be granted access to the one or more data objects comprises analyzing one or more permissions associated with the one or more user data, the one or more roles, and the one or more data objects.

20. The computerized method of claim 15, further comprising determining if the second user is a member of a role mapped to one or more tasks associated with the one or more data objects.
